(19) United States
(12) Patent Application Publication
(10) Pub. No.: US 2014/0035007 A1
(43) Pub. Date: Feb. 6, 2014

(54) Gas Sensor for Determining Substances Contained in a Gas Mixture and Method for Producing such a Sensor

(71) Applicant: Robert Bosch GmbH, Stuttgart (DE)

(72) Inventors: Andreas Krauss, Tuebingen (DE); Alexander Martin, Regensburg (DE)

(73) Assignee: Robert Bosch GmbH, Stuttgart (DE)

(21) Appl. No.: 13/955,147

(22) Filed: Jul. 31, 2013

(30) Foreign Application Priority Data
Aug. 2, 2012 (DE) 10 2012 213 621.5

(51) Int. Cl. G01N 27/414

(52) U.S. Cl. CPC G01N 27/4141
USPC 257/253; 438/49

(57) ABSTRACT

The present disclosure relates to a gas sensor for determining substances contained in a gas mixture, comprising a substrate on which a source electrode, a drain electrode and a gate electrode are arranged, at least one electrically insulating layer being arranged between the substrate and the gate electrode, the gate electrode comprising an electrically conductive ceramic material, and the gate electrode having a range of variation of its thickness that is greater than or equal to one quarter of its total thickness. Such a gas sensor may have in particular improved measuring characteristics and, furthermore, allow itself to be produced in an improved way. The present disclosure also relates to a method for producing such a gas sensor.

This application claims priority under 35 U.S.C. §119 to patent application no. DE 10 2012 213 621.5, filed on Aug. 2, 2012 in Germany, the disclosure of which is incorporated herein by reference in its entirety.

The present disclosure relates to a gas sensor for determining substances contained in a gas mixture. The present disclosure also relates to a method for producing a gas sensor for determining substances contained in a gas mixture.

### BACKGROUND

An example of chemical gas sensors that are currently known are chemically sensitive field-effect transistors that are produced from a thin-film substrate with an electrical insulation. The insulation is in this case arranged between a gate region of the substrate and an electrically conductive layer serving as a gate electrode, the gate electrode being able for instance to interact chemically with a gas to be detected. The electrically conductive layer or the gate electrode may for example be applied by cathode sputtering of a precious metal or a precious metal mixture, for instance comprising platinum and/or rhodium.

Furthermore, a gas sensor for determining gas components in gas mixtures is known from the document DE 10 2007 040 726 A1. Such a sensor comprises a sensor element configured as a field-effect transistor and also a porous, catalytically active layer, which is intended to serve for the breaking down of gas components contained in a gas mixture to be investigated. This catalytically active layer may be arranged as a diffusion barrier in surface contact on the gate electrode. Furthermore, the gate electrode is in particular formed from a mixed precious metal/metal oxide material.

### SUMMARY

The subject matter of the present disclosure is a gas sensor for determining substances contained in a gas mixture, comprising a substrate on which a source electrode, a drain electrode and a gate electrode are arranged, at least one electrically insulating layer being arranged between the substrate and the gate electrode, the gate electrode comprising an electrically conductive ceramic material, and the gate electrode having a range of variation of its thickness that is greater than or equal to one quarter of its total thickness.

Such a gas sensor allows improved measuring characteristics to be achieved and, furthermore, it lends itself to being produced particularly well and inexpensively.

A gas sensor may in this case be in particular a device that can detect substances contained in a gas stream, such as in particular gases, qualitatively and/or quantitatively.

A range of variation of the thickness may in this case also be understood for the purposes of the present disclosure as meaning the margin between a minimum value of the thickness and a maximum value of the thickness or of the total thickness. In this case, the range of variation of the thickness of the gate electrode may relate for instance to the total thickness or maximum thickness of the entire gate electrode, for instance comprising a plurality of single layers or plies, or else in particular to a single layer in the event that a plurality of layers of the gate electrode are provided.

An electrically conductive ceramic may in this case be understood in particular as meaning a material that has a resistivity of less than 10E3 ohm*cm or a band gap of less than 2 eV.

In this case, a ceramic material may be understood as meaning in particular, in a way known per se, a material that is in particular inorganic and nonmetallic. Usually, ceramic materials or products of ceramic materials are formed at rather low temperatures from a raw mass and they can be given typical material properties in particular by a sintering operation carried out at high temperatures.

A previously described gas sensor comprises a field-effect transistor, which in a way known per se comprises a substrate. The substrate may for example be formed from a semiconductor material, such as for instance silicon carbide, gallium nitride or silicon, and, for example by means of corresponding dopings, have a source region, on which a source electrode is arranged, and a drain region, which is spatially separate from the source region and on which a drain electrode is arranged. Between the source region and the drain region, a channel or a space-charge region of the semiconductor substrate may be arranged or formed during operation. Above the space-charge region of the substrate there may be arranged an electrical insulator or an electrically insulating layer, which separates the substrate or the space-charge region from a gate electrode.

A field-effect transistor or a field-effect gas sensor may consequently be understood as meaning in particular, in a way known per se, a structure in which an electrical and physically measurable variable can change due to the action of an electric field when there is adsorption of a specific gas or specific gas ions. This physically measurable variable may for example be an electrical resistance between two terminal contacts or a capacitance, which may be measurable between the electrode layer and a back electrode.

In the case of a previously described sensor formed as a field-effect transistor, an interaction of a gas species for example may have the effect of changing the charge carrier concentration in the space-charge region, in particular by interaction of the gate electrode with the electrical insulation in dependence on the detected species, so that the presence of a gas can be detected on the basis of the changing of the channel current.

In particular, the back electrode may be formed by the semiconductor substrate, in which the source region, the drain region and the channel region of the gas-sensitive field-effect transistor that is arranged between the source region and the drain region are formed, it being possible for at least one surface of the channel region or of the space-charge region to be adjacent to the insulating layer. Such an embodiment offers the advantage that a device or a gas sensor can be used in a wide variety of variants for gas detection, and consequently can be adapted to technologies that are respectively used for the evaluation unit. This may in turn offer the advantage that the gas detectors can be produced on the basis of a semiconductor substrate, it being possible when there are different configurations of the evaluation also for a different configuration of the gas sensors to be implemented. Also, the different embodiments of the gas sensors may have different sensitivities with respect to different types of gases, so that the degree of freedom of the differing design of a gas sensor allows the previously described device to be used for highly precise gas detection.

The provision of a gate electrode that comprises an electrically conductive ceramic material and also has a range of variation of its thickness that is greater than or the same as one quarter of its total thickness has the effect in particular of significantly simplifying the production method. In particular, the production method can be particularly inexpensive, since the ceramic material of the gate electrode can already have sufficient electrical conductivity, making it possible to dispense with the use of additional materials. Altogether it is possible in particular to dispense with the introduction of electrically conductive, metal-based components, in order for example to produce a mixed material, for instance comprising an electrically insulating ceramic and an electrically conductive material. Consequently, a further production step can be saved in comparison with methods from the prior art, thereby allowing the method to be made simple and inexpensive. Rather, the electrically conductive ceramic layer itself can interact with a gas to be detected, and can consequently form the active sensor layer that can interact with the gas to be detected. Furthermore, a previously described roughness can be set particularly well and in a defined manner, in particular using ceramic materials.

In addition, the measuring characteristics or the operating mode can be improved or adapted in a particularly defined way. In detail, the operating mode of the sensor can be adapted to the desired application area or customized to a desired application by means of the defined roughness of the gate electrode. For example, the gate electrode may, in a particularly advantageous way, undertake a number of sensor-relevant functions. This may for example involve a significant increase in the size of the surface of the gate electrode for selectively increasing the influence of the adsorption of gases on the surface or for selectively increasing the influence of for example catalytically occurring surface reactions. Similarly, the rough surface of the gate electrode may have the effect of forming cavities in which for example storage of a gas to be detected, for example oxygen or one or more nitrogen oxides, can take place, whereby the sensitivity can be increased significantly.

In this case, the aforementioned advantages can be achieved in an especially advantageous way in particular whenever a roughness as described above is present in particular on the side facing the gas to be measured, and consequently the side or surface of the gate electrode that is opposite from the substrate. Such roughness may be formed in this case by indentations or similar structures that deviate from an ideal planar surface.

Within the scope of a refinement, the electrically conductive ceramic material may be selected from the group consisting of electrically conductive silicon, zinc, copper, aluminum, tin and/or titanium compounds, in particular from nitrogen- or aluminum-doped silicon carbide, copper oxide, tin oxide and/or titanium nitride. In particular, the aforementioned ceramic materials have good electrical conductivity in combination with high chemical resistance, which can allow a high performance capability of the gas sensor to be produced, such as in particular a high selectivity or sensitivity. It is consequently possible in particular in this refinement to dispense in an advantageous way with any further modification of the gate electrode. For example, it is possible in principle to dispense completely with a further active or precious-metal-based coating on the gate electrode to improve the performance capability of the gas sensor to be produced.

Within the scope of a further refinement, the gate electrode may be porous, it being possible in particular for the gate electrode to have a porosity of from greater than or equal to 2% to less than or equal to 80%. The size of the individual pores may in this case in turn be between 2% and 80%, with preference between 5 and 30%, of the material thickness. In particular in the case of porous materials, particularly high surface roughness can be produced, making it possible in particular that a gas sensor to be produced is capable of performing well. In particular, a porous gate electrode makes it possible in a particularly advantageous way to store components from the gas stream to be measured. For example, oxygen or nitrogen oxides that may be contained in a gas stream and are to be detected can become intercalated in the pores and stored there. An adsorption or conversion of the gas species then taking place in the pores then allows particularly sensitive measuring characteristics to be made possible, and furthermore particularly good selectivity for individual species to be made possible, in particular by customizing the pores in size and/or geometry. In this case, both increased roughness and an increased surface area can be achieved by the porosity, which can make the sensor particularly sensitive. As a result, even smallest amounts of a gas to be detected in a gas mixture can be reliably detected. In this respect, ceramic materials are particularly advantageous. The size and form of the particles of the ceramic layer can be determined during production within wide ranges, for example by appropriate conditions during precipitation of particles from solution or by grinding materials prior to application. Pores may be produced either by choosing the conditions during sintering or by adding sacrificial materials that dissolve during the sintering, such as for instance an organic matrix, or allow themselves to dissolve after production of the layers, in that for example they are water-soluble.

Within the scope of a further refinement, the electrically insulating layer may comprise a ceramic material. The provision of an electrically insulating ceramic material in the electrically insulating layer allows the production method to be simplified still further. For example, the various layers, in particular the electrically insulating layer and the gate electrode applied on it, can be produced by the same or comparable production methods. In particular, the methods known for ceramic layers may be used, whereby it is possible for example to simplify a structure for producing such a sensor. In addition, ceramic materials are particularly stable, so that a gas sensor refined in this way can operate without any problem even under harsh conditions, for example in the exhaust gas line of an internal combustion engine.

In addition, in particular in the case of a ceramic material, a surface with a defined roughness, and consequently improved adhesiveness of a gate electrode on the electrically insulating layer, is made possible in a suitable way. In this case, a person skilled in the art understands that the electrically insulating layer may consist of a ceramic material or may comprise further electrically insulating materials. In the case where further electrically insulating materials are provided, a ceramic material is arranged in particular on the side facing the electrode.

In particular, the electrically insulating ceramic material may comprise a substance or consist of a substance that is selected from the group consisting of silicon-based materials, aluminum-based materials and/or oxides, nitrides and carbides. By way of example, electrically insulating ceramic materials in this case comprise silicon oxide (SiO₂) and aluminum oxide (Al₂O₃). It has surprisingly been found that such ceramic materials may be able to have a particularly good insulating quality and at the same time in this application be able to have a particularly preferred effect as an adhesion promoter. This may for example be caused by a bonding of the ceramic material to the surface of the semiconductor substrate or a first electrically insulating layer, for example by chemical bonds, which can allow a particularly stable bond even in relation to the gate electrode arranged thereover.

It may possibly be the case here that the component of the electrically insulating layer that is located under the electrically insulating ceramic material is formed in particular from layers deposited by thin-film methods, for instance a physical or chemical vapor phase method. These layers may for instance comprise the same material as further electrically insulating ceramic layers, to be specific for example silicon dioxide or silicon nitride or aluminum oxide or a combination of these materials.

Within the scope of a further refinement, a coating may be applied on the gate electrode, it being possible for the coating to be electrically conductive, for example it being possible for the coating to comprise or consist of electrically conductive metallic nanoparticles. In particular by means of a further coating, the sensitivity or selectivity of the gas sensor can be improved further, since the coating can be customizable with respect to the substance to be detected. In particular, the provision of metallic nanoparticles in this refinement allows the geometry of the coating to be adapted particularly easily, whereby particularly defined measuring characteristics can be made possible. Furthermore, nanoparticles allow in a particularly advantageous way the achievement of a catalytically particularly active electrode layer, which can achieve a particularly effective interaction with gases contained in a gas mixture, and can consequently bring about particularly sensitive measuring characteristics. Examples of materials that may be particularly suitable as nanoparticles for forming a coating for a gate electrode comprise for example gold, platinum, rhenium, palladium, rhodium or mixtures of the aforementioned materials. In this case, nanoparticles may be understood for the purposes of the disclosure as meaning in particular particles that have by way of example a diameter in a range from greater than or equal to 3 nm to less than or equal to 300 nm, preferably in a range from 5 to 10 nm.

Within the scope of a further refinement, the gate electrode may have a thickness, in particular a total thickness, that lies in a range from greater than or equal to 10 nm to less than or equal to 2000 nm, preferably from greater than or equal to 30 nm to less than or equal to 200 nm. In this refinement, the gate electrode can have a sufficient thickness in order to form the suitable roughness or porosity, and furthermore also have a sufficient stability. In addition, in this refinement cavities in which a gas to be detected can be at least temporarily immobilized may be formed particularly advantageously, so that in this refinement the sensitivity of a gas sensor can be particularly high.

Within the scope of a further refinement, the electrically insulating layer may have a range of variation of its thickness that is greater than or equal to one quarter of its total thickness. In this refinement, the roughness of the gate electrode may consequently be predetermined by the roughness of the electrically insulating layer, which under some circumstances can allow a particularly simple and inexpensive production method. In addition, in this refinement the electrically insulating layer may serve as an adhesion promoter for the gate electrode, whereby in this refinement the gas sensor can be stable over a particularly long time.

Within the scope of a further refinement, the gate electrode may be formed as a multilayer system. For example, in the implementation of the gate electrode, an electrically conductive, ceramic material may be applied to a thin conductive layer, already deposited uniformly by another method, to form a suitable roughness, or first an electrically conductive ceramic material is applied, merely to form a suitable roughness, and then for example a thin, uniform conductive layer is applied, to form a multilayer system for the gate electrode. This allows a greater selection of materials, since the requirements, such as in particular the formation of the roughness or the electrical conductivity, that the material has to meet can be determined for each layer. In a further refinement, furthermore, the electrically insulating layer may be formed as a multilayer system. Thus, low requirements with respect to stability can be imposed on a first electrically insulating layer, since this layer can then be at least partially covered by a further electrically insulating layer. Therefore, the choice of material of the first electrically insulating layer may be directed in particular at good electrical insulation, or vice versa. With respect to the second electrically insulating layer, the choice of material may in this case be directed in particular at the formation of a suitable roughness.

With regard to further advantages and technical features of the gas sensor according to the disclosure, reference is hereby made explicitly to the explanations given in conjunction with the method according to the disclosure, the figures, and the description of the figures.

The subject matter of the present disclosure is also a method for producing a gas sensor, in particular a gas sensor that is formed as described above, comprising the method steps of:
a) providing a substrate;
b) applying a source electrode and a drain electrode, arranged at a distance from the source electrode, to the substrate;
c) applying at least one electrically insulating layer to the substrate in a region between the source electrode and the drain electrode; and
d) applying a gate electrode to the electrically insulating layer, the gate electrode comprising at least one electrically conductive ceramic material and the gate electrode having a range of variation of its thickness that is greater than or equal to one quarter of its total thickness.

Such a method serves in a particularly advantageous way for producing a gas sensor according to the disclosure. In this case, the method can be carried out particularly simply and inexpensively, so that a gas sensor according to the disclosure can also be obtainable particularly inexpensively.

In this case, in a first method step a), a substrate is provided. The substrate may be formed in a way known per se from a semiconductor material, such as in particular from silicon carbide. It may in this case have a source region and a drain region, at a distance from the source region and present on the same surface, on which regions an electrically conductive layer is arranged as a source electrode and as a drain electrode by methods known per se, as explained later in detail. The source region or the drain region may in this case be formed for example in the case of silicon or silicon carbide as a substrate material by a locally resolved implantation method or in the case of silicon by a diffusion method with an appropriate doping. In particular, the source region and the drain region may be produced by an n+ doping. On the other hand, the substrate may have a p doping, as is known in particular for a field-effect transistor.

In a further method step b), a source electrode and a drain electrode, arranged at a distance from the source electrode, are applied to a substrate provided in this way. Expediently, the source electrode is in this case applied to the source region and the drain electrode is applied to the drain region. Furthermore, the corresponding electrodes may in particular be applied by a physical method, such as for example vapor deposition, or a sputtering method, or by depositing particles from a suspension.

In a further method step c), at least one electrically insulating layer is applied to the substrate in a region between the source electrode and the drain electrode. In this case, the electrically insulating layer may be applied directly and without any intermediary to the substrate, or indirectly to a further electrically insulating layer arranged on the substrate, in which case the electrically insulating layer may in particular be formed from a multilayer structure. In this case, the electrically insulating layer may for example be produced or deposited by methods that are customary in semiconductor processes. Suitable methods comprise for example physical deposition methods, such as for instance PVD methods, magnetron sputtering or else chemical deposition methods, such as for instance chemical vapor deposition (CVD) or atomic layer deposition (ALD). The methods may in this case be modified temporarily, for instance by choice of depositing temperatures in the case of CVD or ALD or background pressures in the case of sputtering, such that a rough surface is produced after the deposition. The material of the electrically insulating layer may in this case be a ceramic material or an electrically insulating material that is known from semiconductor technology.

In a further method step d), in the case of a previously described method a gate electrode is applied to the electrically insulating layer, the gate electrode comprising an electrically conductive ceramic material and the gate electrode having a range of variation of its thickness that is greater than or equal to one quarter of its total thickness. The roughness of the gate electrode can be set by the application of the gate electrode, by for instance an application step and a subsequent structuring step or a partial dissolving of the layer, by which the desired roughness or porosity can be produced.

In the case of thin-film methods that can be used, it can for instance be ensured before the deposition on an electrically insulating layer that uniform deposition from the vapor phase does not take place, but instead there form particles that are deposited as a rough layer. As mentioned above, a compact, solid layer could be deposited and subsequently structured, for example by locally resolved etching carried out by means of a mask, for example dry etching with plasma or wet etching in solution. Furthermore, an appropriate roughness can be set by the provision of an electrically insulating layer that is already rough.

In particular, the gate electrode may be applied by a sol-gel method, spin coating, doctor blading, drip application, spray application, flame spray pyrolysis or a combination of the aforementioned methods, whereby in particular a multilayered gate electrode can be achieved. The electrically conductive ceramic material may be achieved for example by depositing from a solution onto the gate region of the field-effect transistor or the electrically insulating layer arranged in the gate region. The method may in this case in a way known per se a hydrolysis of metal alcoholates, for example an aluminum alcoholate, a condensation under reaction conditions, in which a layer comprising a ceramic material forms on the surface of the electrically insulating layer or nanoparticles form in the desired size and are adsorbed on the insulating layer. Furthermore, drying and thermal treatment steps for the pyrolysis of organic radicals and for the initiation of selective sintering processes may be comprised. By such methods it is possible in a particularly simple way to be able to apply the ceramic material to a first electrically insulating layer or to the substrate in a locally resolved manner and in a suitable and defined thickness and roughness. Such methods can also be carried out simply and, as a result, are particularly inexpensive in application. Furthermore, the corresponding properties of the ceramic layer, such as in particular its thickness, porosity and surface roughness, can be set thereby in a particularly advantageous way, because a method known from ceramic technology allows very good parameter variations. Thus, for instance, particles can already be produced before deposition from solution onto a surface and be varied in many properties, for example form, size and reactivity during sintering. This has the effect that a sensor according to the disclosure can be used particularly well in a desired application area.

With regard to further advantages and technical features of the method according to the disclosure, reference is hereby made explicitly to the explanations given in conjunction with the gas sensor according to the disclosure, the figures, and the description of the figures.

### BRIEF DESCRIPTION OF THE DRAWINGS

Further advantages and advantageous refinements of the subjects according to the disclosure are illustrated by the drawings and are explained in the description that follows. It should be noted here that the drawings are only of a descriptive character and are not intended to restrict the disclosure in any form. In the drawings:

FIG. 1 shows a schematic representation of an embodiment of a gas sensor according to the disclosure; and

FIG. 2 shows a sectional view to illustrate an embodiment of the present disclosure.

### DETAILED DESCRIPTION

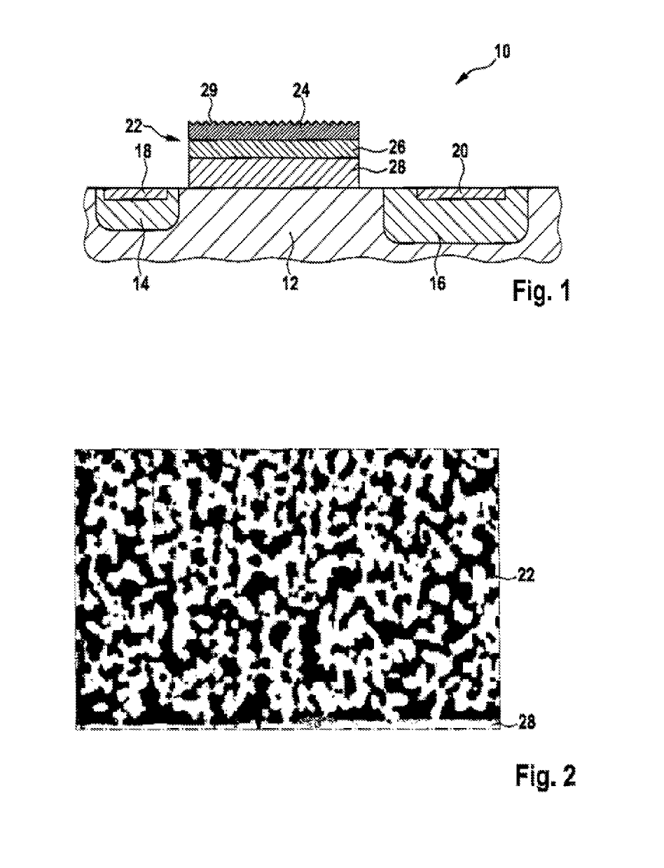

In FIG. 1, a refinement of a gas sensor 10 according to the disclosure for detecting substances contained in a fluid stream is schematically shown. Such a gas sensor 10 may be used in particular in the exhaust gas line of an internal combustion engine. In an actual application, the device 10 may be used as an oxygen sensor and/or as a nitrogen-oxide sensor in the exhaust gas line of a motor vehicle.

The gas sensor 10 in this case comprises in particular a chemically sensitive field-effect transistor. In detail, a substrate 12 is provided, formed in particular from a semiconductor material. With preference, the substrate 12 may be formed from silicon carbide. Further non-restrictive examples comprise for instance silicon, gallium arsenide (GaAs) and gallium nitride (GaN). By introducing appropriate dopings in the case of silicon carbide, the substrate comprises a source region 14 and a drain region 16, on which a corresponding terminal and a corresponding electrode, in particular a source electrode 18 and a drain electrode 20, are arranged.

Also arranged on the substrate 12 is a gate electrode 22, which may for instance comprise a number of layers or plies 24, 26. Also arranged between the substrate 12 and the gate electrode 22 is an electrically insulating layer 28. In this case, one or more further electrically insulating layers may be arranged between the electrically insulating layer 28 and the substrate 12, or the electrically insulating layer 28 may be of a multilayered form.

The gate electrode 22 or a surface of the gate electrode 22, in particular the side of the gate electrode 22 that can be exposed to gas, has in this case such a roughness that the range of variation of its thickness is greater than or equal to one quarter of its total thickness. The gate electrode 22 may also be porous and for example have a porosity of from greater than or equal to 2% to less than or equal to 80%. Furthermore, the gate electrode may be formed, in particular completely formed, from an electrically conductive ceramic material, it being possible for the electrically conductive ceramic material to be selected from the group consisting of silicon, zinc, copper, aluminum, tin and/or titanium compounds, in particular doped silicon carbide and/or titanium nitride.

With respect to the electrically insulating layer 28, it may comprise an electrically insulating ceramic material, which is in particular selected from the group consisting of electrically nonconductive silicon-based materials, aluminum-based materials and/or oxides, nitrides and carbides. In particular, the ceramic material may comprise silicon oxide or aluminum oxide or in particular be formed completely from these materials. The electrically insulating layer, in particular all of the electrically insulating layers 28, may, like the gate electrode 22, also have a thickness in a range from greater than or equal to 10 nm to less than or equal to 2000 nm.

Furthermore, an additional coating, for example comprising or consisting of electrically conductive particles, in particular metallic nanoparticles, may be applied on the gate electrode 22.

A method for producing a previously described gas sensor 10 may in particular comprise the following method steps of:
a) providing a substrate 12;
b) applying a source electrode 18 and a drain electrode 20, arranged at a distance from the source electrode 18, to the substrate 12;
c) applying at least one electrically insulating layer 28 to the substrate 12 in a region between the source electrode 18 and the drain electrode 20 or between the source region 14 and the drain region 16; and
d) applying a gate electrode 22 to the electrically insulating layer 28, the gate electrode 22 comprising an electrically conductive ceramic material and the gate electrode 22 having a range of variation of its thickness that is greater than or equal to one quarter of its total thickness.

FIG. 2 shows furthermore a sectional view of a gas sensor 10. Such a gas sensor 10 comprises an electrically insulating layer 28, for instance of a thickness of 30 nm, which is arranged on a semiconductor substrate 12, by means of a thin-film method. On the electrically insulating layer 28 there can be seen the porous and electrically conducting ceramic material, which may serve as a gate electrode 22 and which is applied for instance by means of an aerosol spray-printing method. In this case, only one layer 24 or both layers 24, 26 may be porous. A previously described thickness or roughness can be achieved from such a ceramic material, for instance by means of structuring.

What is claimed is:

1. A gas sensor for determining substances contained in a gas mixture, comprising:
a source electrode;
a drain electrode;
a gate electrode including an electrically conductive ceramic material;
a substrate on which the source electrode, the drain electrode and the gate electrode are positioned; and
at least one electrically insulating layer interposed between the substrate and the gate electrode,
wherein the gate electrode has a total thickness and a range of variation of thickness that is greater than or equal to one quarter of the total thickness.

2. The gas sensor according to claim 1, wherein the electrically conductive ceramic material includes at least one material selected from the group consisting of electrically conductive silicon, zinc, copper, aluminum, tin, and titanium compounds.

3. The gas sensor according to claim 1, wherein the gate electrode is porous.

4. The gas sensor according to claim 1, wherein the at least one electrically insulating layer includes a ceramic material.

5. The gas sensor according to claim 1, further comprising:
a coating applied on the gate electrode.

6. The gas sensor according to claim 1, wherein the total thickness of the gate electrode is greater than or equal to 10 nm and less than or equal to 2000 nm.

7. The gas sensor according to claim 1, wherein the electrically insulating layer has an insulating layer total thickness and a range of variation of insulating layer thickness that is greater than or equal to one quarter of the insulating layer total thickness.

8. The gas sensor according to claim 1, wherein the gate electrode includes a plurality of layers.

9. A method for producing a gas sensor, comprising:
applying a source electrode to a substrate;
applying a drain electrode to the substrate spaced apart from the source electrode;
applying at least one electrically insulating layer to the substrate in a region between the source electrode and the drain electrode; and
applying a gate electrode to the electrically insulating layer, the gate electrode including at least one electrically conductive ceramic material and the gate electrode having a total thickness and a range of variation of thickness that is greater than or equal to one quarter of the total thickness.

10. The method according to claim 9, wherein the gate electrode is applied by at least one of a sol-gel method, spin coating, doctor blading, drip application, spray application, and flame spray pyrolysis.

11. The gas sensor according to claim 2, wherein the electrically conductive ceramic material includes at least one of doped silicon carbide and titanium nitride.

12. The gas sensor according to claim 3, wherein the gate electrode has a porosity of from greater than or equal to 2% to less than or equal to 80%.

13. The gas sensor according to claim 4, wherein the ceramic material of the at least one electrically insulating layer includes a substance that is selected from the group consisting of (i) silicon-based materials, (ii) aluminum-based materials, and (iii) oxides, nitrides, and carbides.

14. The gas sensor according to claim 5, wherein the coating is electrically conductive.

15. The gas sensor according to claim 14, wherein the coating includes electrically conductive metallic nanoparticles.
